(19) United States
(12) Patent Application Publication
(10) Pub. No.: US 2006/0162750 A1
(43) Pub. Date: Jul. 27, 2006

(54) Adjustable-angle pipe and rod pushing device

(76) Inventor: Robert A. Wilbert, Stockholm, NJ (US)

Correspondence Address: JACOBSON HOLMAN PLLC, 400 SEVENTH STREET N.W., SUITE 600, WASHINGTON, DC, 20004, US

(21) Appl. No.: 11/039,934

(22) Filed: Jan. 24, 2005

(51) Int. Cl. B08B 3/02

(52) U.S. Cl. 134/122 R; 134/64 R; 134/167 R

(57) ABSTRACT

A rod and pipe pushing device having opposed belt structures for engaging opposite sides of an elongated member that is to be pushed into an embedded pipe having a larger diameter than the elongated member. The device includes a pipe pushing apparatus pivotally mounted on a main support frame having an angle adjustment assembly that provides full angular adjustment capability to the pipe pushing apparatus. With such angular adjustment capability, an elongated member to be pushed by the pipe pushing apparatus can be readily aligned with an embedded pipe or bore hole of larger diameter for insertion therein. The elongated member may be provided with various cleaning and inspection tips enabling the rod and pipe pushing device, which is highly transportable, to be used effectively to clean and inspect a wide range of horizontally to vertically laid piping at various locations efficiently and cost-effectively.

### BACKGROUND OF THE INVENTION

1. Field of the Invention

The present invention relates generally to devices for pushing an elongated member such as a pipe, tube or rod into a bore hole of larger diameter pipe or tubing to perform various functions thereby and, more specifically, to such pushing device which can be angularly adjusted to push the elongated member at angles between a generally vertical position and a generally horizontal position.

2. Description of the Related Art

There are a number of applications in which horizontally or generally horizontally running pipes are run over a distance for various purposes, generally being buried or embedded in the ground. For example, in some landfills, generally horizontal piping is embedded in the landfill area during the establishment thereof in order to provide a means of accessing a central cavity of the landfill, for effecting gas and/or liquid exchange with core areas, i.e., providing ventilation, etc. For the pipes to remain effective in performing these functions, free passage therethrough must be maintained and hence it is necessary to be able to inspect and/or clean the pipe bores. Similarly, vertically or generally vertically running pipes such as those used in well construction may also require inspection, cleaning, etc.

Therefore, a need exists for a pipe and rod pushing device that can adapt to various pipe insertion angles to provide a range of pipe maintenance and inspection capabilities in a readily transportable and economic manner.

### OBJECTS AND SUMMARY OF THE INVENTION

In view of the foregoing, one object of the present invention is to overcome the difficulties of cleaning and/or inspecting horizontally running pipes by providing a pipe and rod pushing device that is able to push a pipe or rod into horizontally laid piping of a larger diameter while the element being pushed is provided with a suitable cleaning or inspection tip.

Another object of the present invention is to provide a pipe and rod pushing device that has an adjustable insertion angle for ease of alignment with fixed piping laid at various angles ranging from horizontal to vertical orientations.

A further object of the present invention is to provide an adjustable-angle pipe and rod pushing device having motor-driven opposed drive belt assemblies for engaging and maintaining contact with opposite surfaces of an elongated member while automatically adjusting to accommodate the passage of various tips and other equipment that may be provided on such member.

An additional object of the present invention is to provide a pipe and rod pushing device mounted on a frame that has and angle adjustment assembly that allows the device to be set for different pipe insertion angles and that also enables the pushing device to be fastened to a truck or trailer.

A still further object of the present invention is to provide a pipe and rod pushing device that is portable and lightweight, being easily transported to and adjusted for entry points of piping laid at virtually any angle from vertical to horizontal.

Another object of the present invention is to provide a pipe and rod pushing device able to accommodate a plurality of different tip components interchangeably fitted on the elongated member being inserted for cleaning and inspection of pipe bores.

Yet another object of the present invention is to provide a rod and pipe pushing device that is not complex in structure and which can be manufactured at low cost but yet efficiently handle a wide range of rod and pipe insertion and extraction functions.

In accordance with these and other objects, the present invention is directed to a rod and pipe pushing device having opposed drive belt assemblies for engaging opposite sides of an elongated member that is to be pushed into an embedded pipe having a larger diameter than the elongated member. The device is built upon a frame that provides full angle adjustment capability to facilitate alignment of the elongated member with the embedded pipe. The elongated member may be provided with various cleaning and inspection tips that are readily accommodated for pass-through by the opposed drive belt assemblies. Accordingly, the rod and pipe pushing device of the present invention, which is highly transportable, may be used effectively to clean and inspect a wide range of horizontally to vertically laid piping applications efficiently and cost-effectively.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a side view of an adjustable angle pipe pusher device in accordance with the present invention with the pipe pusher apparatus in a fully horizontal position.

FIG. 2 is an end view of the pipe pusher device taken along line 2-2 of FIG. 1.

FIG. 3 is a bottom view of the pipe pusher device taken along line 3-3 of FIG. 1.

FIG. 4 is an end view of the pipe pusher device shown in FIG. 1 with the pipe pusher apparatus in a fully upright vertical position.

FIG. 5 is top view of the pipe pusher device taken along line 5-5 of FIG. 4.

FIG. 6 is a bottom view of the pipe pusher device taken along line 6-6 of FIG. 4.

FIG. 7 is a side view of the pipe pusher device of FIG. 1 with the pipe pusher apparatus positioned in a fully downward vertical position in accordance with the present invention.

FIG. 8 is a side view of an alternative embodiment of an adjustable angle pipe pusher device in accordance with the present invention with the pipe pusher apparatus in a horizontal position.

FIG. 9 is a side view of the alternative embodiment of FIG. 8 with the pipe pusher apparatus in a fully downward vertical position in accordance with the present invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

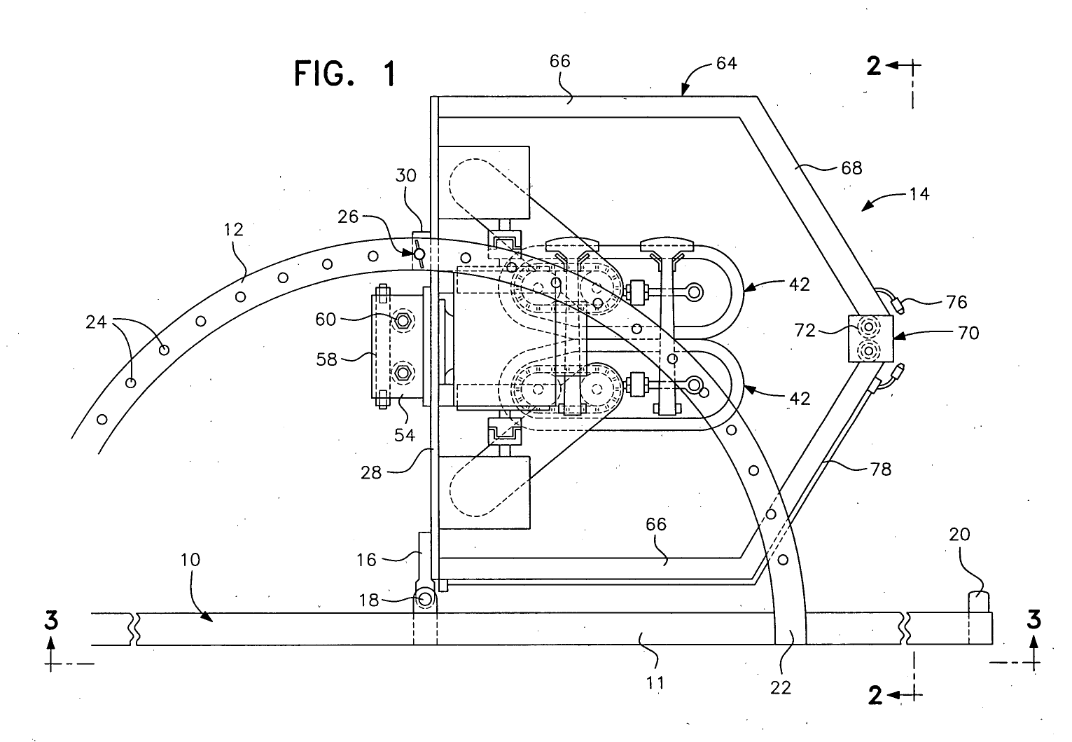

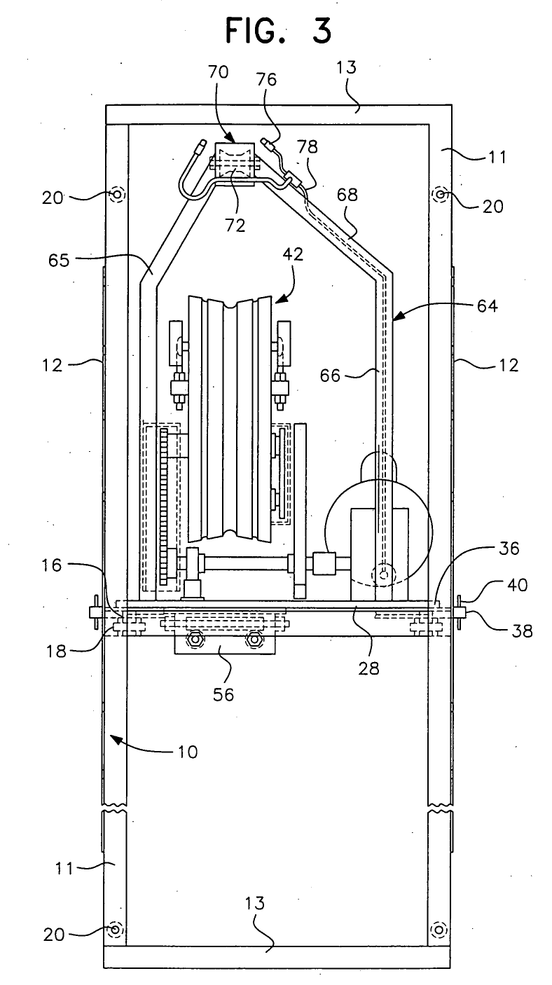

Referring now specifically to the drawings, the pipe and rod pushing device of the present invention as set forth in FIGS. 1-7 includes a main support frame 10 having a pair of angle adjustment arms 12 one on each side of the frame 10, and a pipe pusher apparatus which is generally designated by the reference numeral 14. While described herein as a “pusher apparatus”, it will be understood by persons of skill in the art that such apparatus may be readily reversed through switching of the drive direction to provide pulling capability. Furthermore, as described hereinafter, the “pusher apparatus” according to the present invention provides both pushing and pulling capability, generally being used to first push a rod or pipe into a bore hole or larger diameter pipe for cleaning, inspection, etc., and thereafter pulling the same rod or pipe back out of the bore hole or larger diameter pipe once the desired procedure has been completed. Therefore, as used herein the “pipe pusher apparatus” is intended to refer to an apparatus used for both pushing and pulling of an elongated member such as a pipe, rod, tubing, etc.

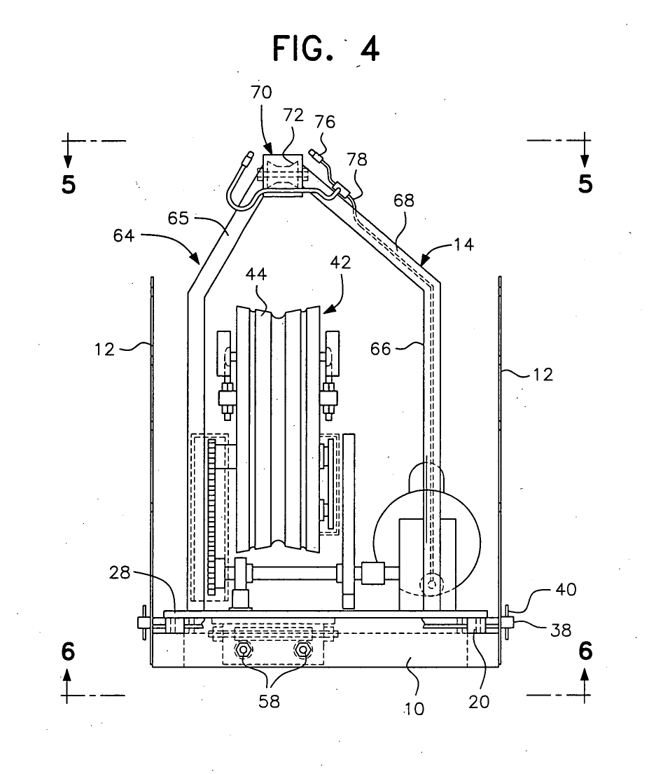

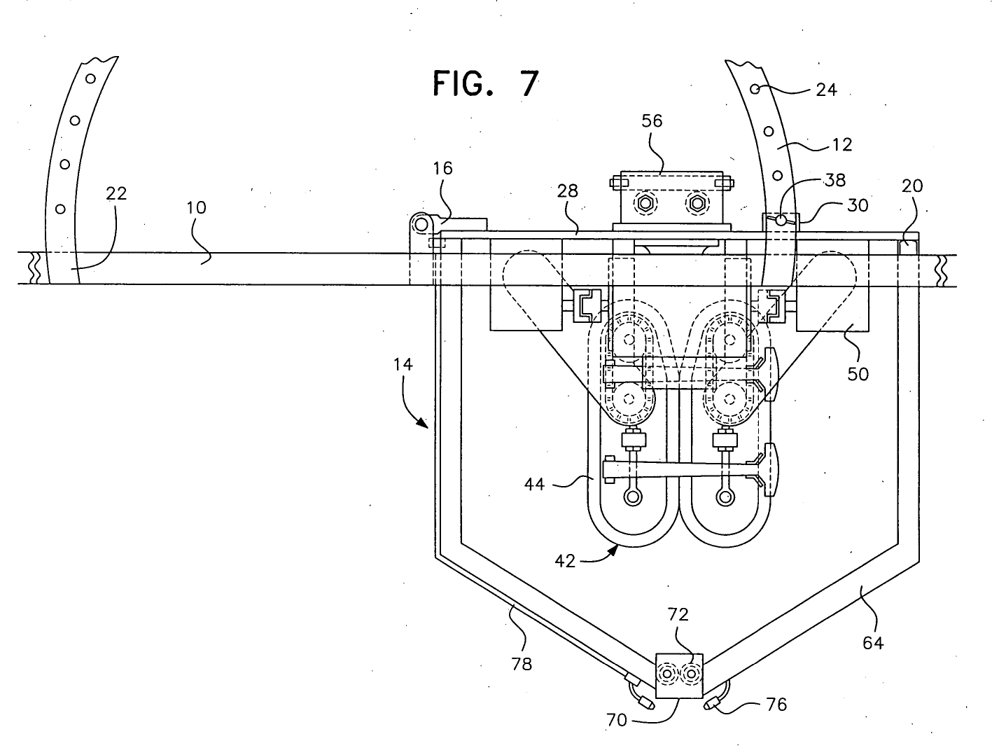

The main support frame 10 is generally rectangular in shape with side frame members 11 and end frame members 13 preferably welded together to form rectangular frame 10. The frame 10 can be suitably coupled to a truck or trailer using a conventional hitch arrangement (not shown) for easy transport. Centrally mounted on each side frame member 11 is a hinge assembly 16 by which the pipe pusher apparatus 14 is mounted to the frame 10. The hinge assembly 16, which may be embodied as a hinge pin connection 18, allows the pipe pusher apparatus 14 to pivot through a range of motion relative to the frame 10. Specifically, the pipe pusher apparatus 14 can be pivoted from a fully upright vertical position as shown in FIG. 4, through a horizontal position as shown in FIG. 1, to a fully downward vertical position as shown in FIG. 7. The outermost pivot positions are defined by stop elements 20 provided on the side frame members 11.

As shown in FIGS. 1 and 7, each angle adjustment arm 12 has an arched, generally semi-circular construction, with the ends 22 thereof being coupled, preferably by welding, to the sides 11 of the main support frame 10 such that the plane of the arms 12 is generally perpendicular to the plane of the frame 10. Alternatively, the ends 22 may be connected to the sides 11 of frame 10 using other coupling mechanisms, including those which would allow the arms to be moved for adjustment of the position of the arms on the frame, if desired.

A plurality of apertures 24 are provided in each arm 12, spaced generally equidistantly from one another between the two ends 22, with corresponding apertures 24 in the two arms 12 being in alignment with one another. When the pusher apparatus 14 has been pivoted on the hinge assembly 16 to a desired angle, a fastening element, generally designated by the reference numeral 26, is inserted through the corresponding pair of aligned adjustment arm apertures 24 so as to lock the pipe pusher apparatus 14 to the frame 10 at the angle defined by such apertures 24. According to the embodiments disclosed herein, the pusher apparatus is pivoted manually. However, various automated or mechanical devices could be employed to assist in or perform the needed adjustments in position.

The pipe pusher apparatus 14 includes a base plate 28 that secures the pipe pusher apparatus 14 to the hinge assembly 16 of the frame 10. A pair of U-shaped brackets 30 are fastened to the underside 34 of the base plate 28 adjacent each longitudinal side 36 thereof so that the “U” portion thereof is aligned with the apertures 24 in the adjustment arm 12. To lock the pipe pusher apparatus 14 at a desired angle, the fastening element 26, which may be embodied as an elongate member such as a rod 38, is inserted through the appropriate aperture 24 in the near adjustment arm 12, through the U-shaped brackets 30 on each longitudinal side 36 of the base plate 28, and through the aperture 24 in the far adjustment arm 12. Both ends of the rod 38 are then secured with locking pins 40 or the like, thus allowing the rod 38 to be easily removed from either side. This ease of adjustment and range of angular orientation provides for ready access to and maintenance of pipes laid at virtually any orientation.

As shown in the drawing figures, the base plate 28 supports a pair of opposed drive belt assemblies generally designated by the reference numeral 42. Each drive belt assembly 42 includes a belt 44, with the belt assemblies 42 being pivotable toward and away from one another. When the belt assemblies 42 are pivoted toward one another so as to place the belts 44 in a juxtaposed relationship as shown in FIG. 1, the interfacing surfaces of the belts 44 define a pipe gripping area 46 therebetween for engaging and automatically maintaining a geometrical advantage between opposite surfaces of the pipe or rod to be pushed. The belts 44 can be driven by an electric, gas, hydraulic or pneumatic motor 48 and two worm gear speed reducers 50 maintain a mechanical advantage. Such a paired drive belt assembly configuration with associated driving elements in accordance with that intended for use within the present invention has been developed and is fully disclosed in U.S. Pat. No. 5,253,845, the disclosure of which is expressly incorporated by reference as if fully set forth herein.

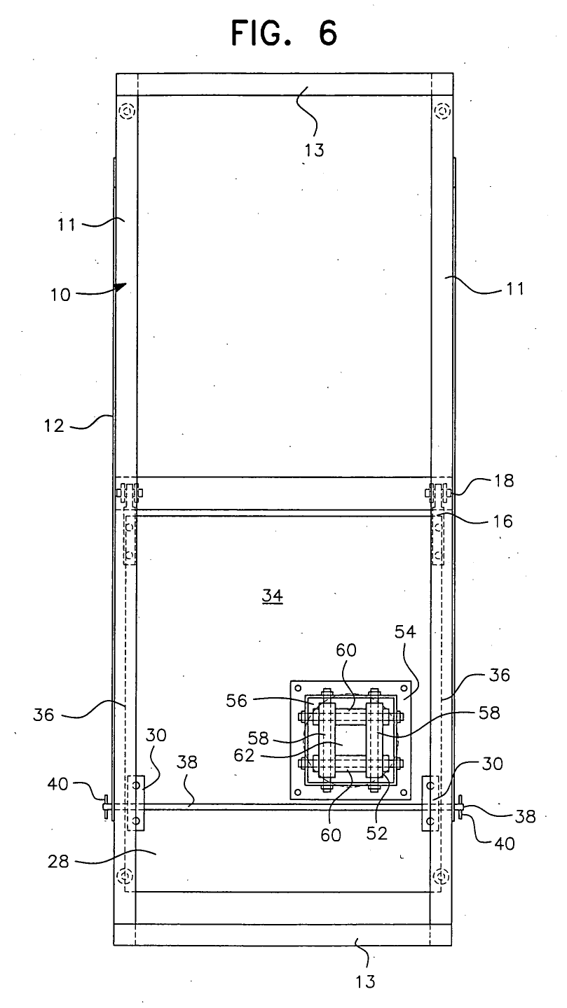

As shown in FIG. 6, the base plate 28 of the pipe pusher apparatus 14 has a through hole 52 therein for passage of the pipe or rod being pushed. The hole 52 is in alignment with the pipe gripping area 46 when the belts 44 are in juxtaposed relationship. Mounted to the underside 34 of the base plate 28 so as to encompass the hole 52 is a mounting bracket 54 with an adjustable base plate roller guide, generally designated by the reference numeral 56. The base plate roller guide 56 includes two pairs of rollers 58, 60, each pair being generally perpendicular to the other pair, and the rollers of each pair being spaced to define a central pipe guide opening 62. The base plate roller guide 56 serves to center an elongated member to be pushed in the central pipe guide opening 62, thereby directing such elongated member into the pipe gripping area 46 of the drive belt assemblies 42 for pushing.

According to the present invention, the pipe pusher apparatus 14 further includes a guide support frame 64 mounted on the base plate 28. The guide support frame 64 includes preferably four struts 65 including base components 66 that are affixed and generally perpendicular to the base plate 28, and angled components 68 distal from the base plate 28 which converge with one another at an adjustable frame apex roller guide, generally designated by reference number 70.

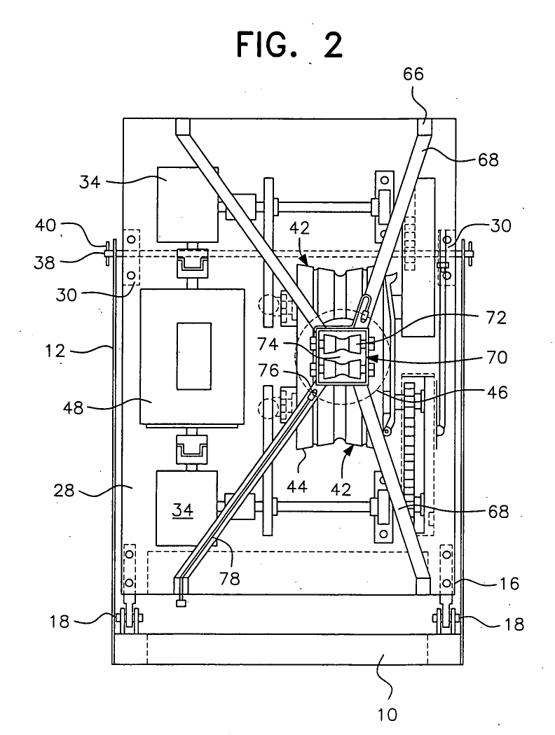

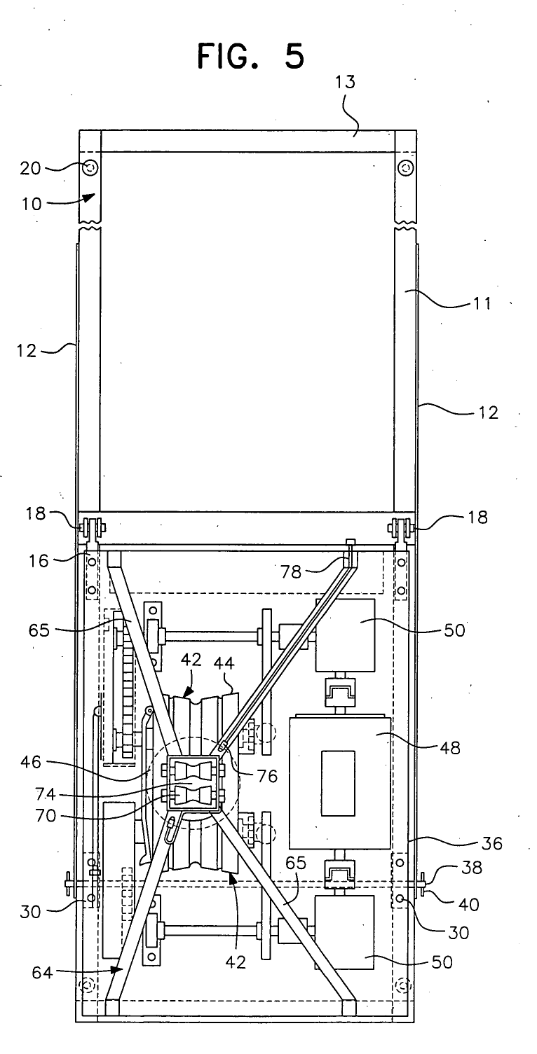

As best seen in FIGS. 2 and 5, the adjustable frame apex roller guide 70 includes a pair of rollers 72 placed side by side with variable spacing so as to define a pipe passage area 74 therebetween. The pipe passage area 74, which is in alignment with the pipe gripping area 46 of the drive belt assemblies 42 when the belts 44 are in their juxtaposed position, and hence also in alignment with the central pipe guide opening 62 of the base plate roller guide 56, serves to center the pushed pipe or rod within the bore hole or pipe which is being cleaned or inspected.

In accordance with the preferred embodiments shown herein, spray nozzles 76 are secured to the angled portions 68 of the guide support frame 64 adjacent the frame apex roller guide 70. These nozzles 76 are coupled to a high pressure fluid supply (not shown) by appropriate tubing 78. When the pusher apparatus 14, having been used to push a rod or pipe, is put into a reverse mode for the retrieval of the pushing pipe or rod, the spray nozzles 76 can be activated to direct high pressure liquid toward the rollers 72 in order to wash debris off of the retrieved equipment. This not only cleans the inserted rod or pipe for subsequent use but also prevents unwanted transfer of dirt and debris to the belts 44 and roller guides 56, 70.

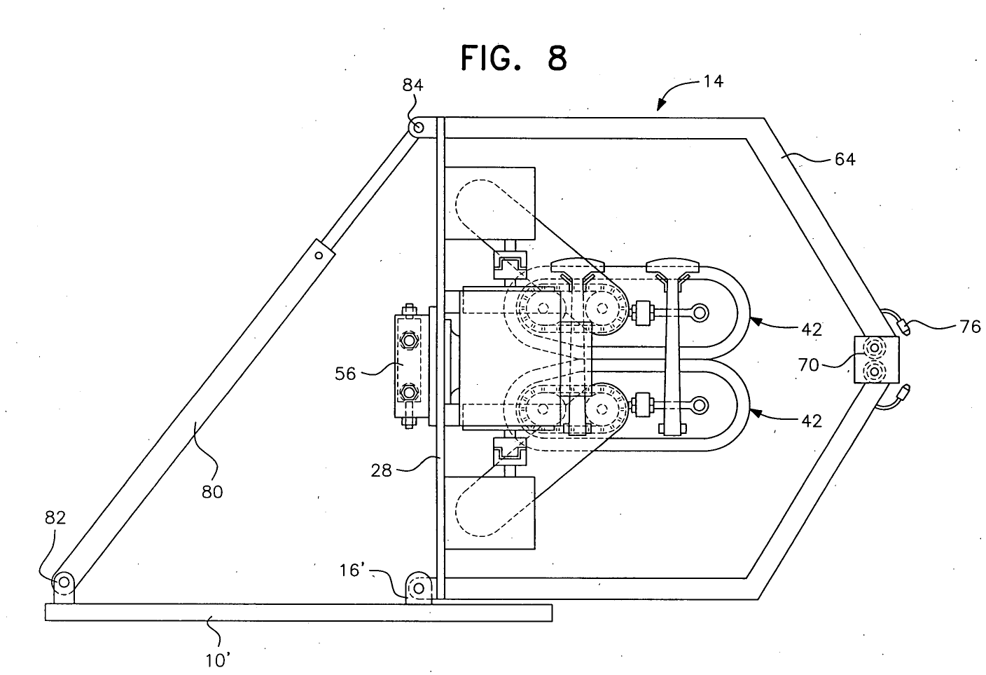

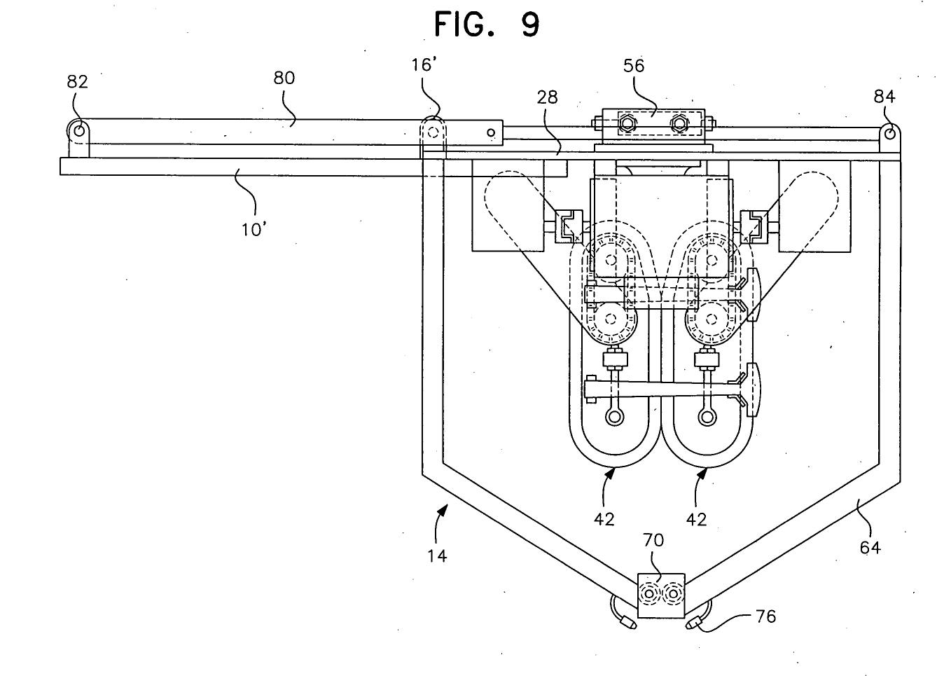

As has just been described, the angular adjustment of the pusher apparatus 14 is effected using the pair of arms 12, hinge assembly 16 and brackets 30 which constitute an angle adjustment assembly. An alternative embodiment of the present invention in which the angle adjustment assembly is embodied with a hydraulic cylinder support arm 80 and hinge assembly 16′ is illustrated in FIGS. 8 and 9. As shown, the support arm 80 is hingedly coupled to the main support frame 10′ by pivot 82 and to the pusher apparatus 14 by pivot 84. By elongating the hydraulic support arm 80, the pipe pusher apparatus 14 can be rotated around hinge assembly 16′ from the horizontal position in FIG. 8 to the vertical position in FIG. 9. In this embodiment there are no separate angle adjustment arms 12. The hydraulic cylinder support arm 80 preferably is of a type that can be locked in a desired extended position, as is known with cylinders of this type. Furthermore, as with the first embodiment two such hydraulic cylinder arms 80 may be provided, one on either side of the base plate, for greater stability.

As described herein, the pipe pusher device according the present invention is able to push a pipe, multiple pipes, tubing or rods into a bore hole or larger diameter pipe or tubing. The insertion end of the article being pushed may be equipped with a cleaning tip, pressure washing tip, suction debris removal tip or video examination camera; tips such as these are commercially available as would be known by persons of ordinary skill in the art. With initial direction provided by the base plate roller guide, the cooperating belt drive assemblies automatically adjust the contact area of the belts to accommodate the various tips and other equipment which may be passed through the apparatus, and the frame apex roller guide provides final centering alignment within the pipe being entered. The surfaces of the belts may further include grooves of varying sizes to facilitate desired placement of the elongated member being pushed. This pipe and rod gripping and guiding capability, in combination with the fully adjustable frame which enables the working angle to be adjusted for alignment with any angled bore hole or tubing, results in an apparatus that is able to adapt to virtually any pipe configuration for performing a variety of pipe inspection and maintenance functions in a manner not known in the prior art.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A rod and pipe pushing device comprising:
a main support frame having an angle adjustment assembly mounted thereon that includes a hinge assembly; and
a pipe pushing apparatus pivotally connected to said main support frame through said hinge assembly and having opposed drive belt assemblies for engaging opposite sides of an elongated member to be pushed at an insertion angle into a larger diameter bore hole, an angle of said pipe pushing apparatus relative to said frame being adjustable by pivoting of said pushing apparatus on said hinge assembly and locking of said pipe pushing apparatus at a desired angular position using said angle adjustment assembly, said desired angular position determining said insertion angle of an elongated member engaged by said opposed drive belt assemblies.

2. The device as set forth in claim 1, wherein said pipe pushing apparatus further includes a base plate supporting said opposed drive belt assemblies and having a hole therein generally aligned with a pipe gripping area at an interface between said opposed drive belt assemblies such that an elongate member passes through said hole for engagement within said pipe gripping area.

3. The device as set forth in claim 2, wherein said base plate includes a mounting bracket encompassing said hole, said mounting bracket supporting a base plate roller guide having rollers that define a central pipe guide opening for centering said elongated member within said hole.

4. The device as set forth in claim 3, wherein said rollers include a first pair of rollers and a second pair of rollers, said first and second pairs of rollers being generally perpendicular to each other, a spacing between the rollers of each pair being adjustable to suit a diameter of an elongate member being pushed or pulled.

5. The device as set forth in claim 2, wherein said base plate includes an outwardly extending guide support frame that supports a frame apex roller guide located remotely from said base plate, said frame apex roller guide having a pair of rollers that define a pipe passage area generally aligned with said pipe gripping area.

6. The device as set forth in claim 5, wherein said guide support frame includes a spray nozzle with high pressure fluid supply positioned adjacent said frame apex roller guide for washing debris from an elongated member before being pulled therethrough.

7. The device as set forth in claim 5, wherein a spacing of said pair of rollers is adjustable to suit a diameter of an elongate member being pushed or pulled.

8. The device as set forth in claim 1, wherein said angle adjustment assembly further includes an angle adjustment arm formed as a semi-circular arch extending upwardly from and having two ends secured to said main support frame, said arch including a plurality of apertures spaced therealong for receiving a fastening element to secure said pipe pushing apparatus to said arm at the desired angular position.

9. The device as set forth in claim 8, wherein said angle adjustment assembly includes a pair of spaced angle adjustment arms with generally aligned apertures, said opposed drive belt assemblies being mounted on a base plate positioned between said pair of angle adjustment arms, said fastening element extending through corresponding apertures in said pair of arms and through a bracket on said base plate to secure said desired angular position.

10. The device as set forth in claim 2, wherein said angle adjustment assembly further includes a hydraulic cylinder support arm hingedly connected to said frame and to said pipe pushing apparatus.

11. An elongated member pushing device comprising:
a main support frame having a hinge assembly and a spaced pair of adjustable angle arms mounted thereon, each of said adjustable angle arms having a plurality of adjustment settings, said arms and said settings being in alignment with one another; and
a pipe pushing apparatus having opposed drive belt assemblies for engaging opposite sides of an elongated member to be pushed at an insertion angle into a larger diameter bore hole, said pipe pushing apparatus including a base plate extending between said pair of arms and supporting said drive belt assemblies, said base plate pivotally connecting said pipe pushing apparatus to said hinge assembly of said main support frame, an angle of said pipe pushing apparatus relative to said frame being adjusted by pivoting said pipe pushing apparatus on said hinge assembly and coupling the base plate of said pipe pushing apparatus to said adjustable angle arms at a desired angular position using one of said plurality of adjustment settings thereon, said desired angular position determining said insertion angle of the elongated member engaged by said opposed drive belt assemblies.

12. The device as set forth in claim 11, wherein said base plate has a hole therein generally aligned with a pipe gripping area at an interface between said opposed driven belt assemblies such that said elongate member passes through said hole for engagement within said pipe gripping area, said base plate further including a mounting bracket encompassing said hole, said mounting bracket supporting a base plate roller guide that defines a central pipe guide opening for centering said elongated member within said hole.

13. The device as set forth in claim 12, wherein said base plate roller guide includes a first pair of rollers and a second pair of rollers, said first and second pairs of rollers being generally perpendicular to each other, a spacing between the rollers of each pair being adjustable to suit a diameter of the elongate member being pushed or pulled.

14. The device as set forth in claim 11, wherein said base plate includes an outwardly extending guide support frame that supports a frame apex roller guide located remotely from said base plate, said frame apex roller guide having a pair of rollers that define a pipe passage area generally aligned with a pipe gripping area at an interface between said opposed drive belt assemblies.

15. The device as set forth in claim 14, wherein said guide support frame includes a spray nozzle with high pressure fluid supply positioned adjacent said frame apex roller guide for washing debris from the elongated member before being pulled therethrough.

16. The device as set forth in claim 14, wherein a spacing of said pair of rollers is adjustable to suit a diameter of the elongate member being pushed or pulled.

17. The device as set forth in claim 11, wherein each of said angle adjustment arms is a semi-circular arch extending upwardly from and having two ends secured to said main support frame, said plurality of adjustment settings including a plurality of apertures spaced along said arch for receiving a fastening element to secure said base plate to said arms at the desired angular position.

18. An elongate member pushing/pulling device comprising a main support frame having an angle adjustment assembly mounted thereon, and a pipe pushing apparatus pivotally connected to said main support frame and having opposed drive belt assemblies defining a pipe gripping area for engaging opposite sides of an elongated member to be pushed at an insertion angle into a larger diameter bore hole, a first guide element for centering said elongated member within said pipe gripping area, and a second guide element for centering said elongated member within the larger diameter bore hole, said first and second guide elements and said pipe gripping area being substantially in linear alignment, an angle of said pipe pushing apparatus relative to said frame being adjustable by pivoting and locking said pipe pushing apparatus at a desired angular position with said angle adjustment assembly, said angular position determining said insertion angle of the elongated member engaged by said opposed drive belt assemblies.

19. The device as set forth in claim 18, wherein said first and second guide elements include pairs of rollers, a spacing of the rollers within each pair being adjustable to accommodate and center the elongate member being pushed or pulled.

20. The device as set forth in claim 18, wherein said second guide element includes a pair of rollers supported by a guide support frame, said guide support frame having a spray nozzle with high pressure fluid supply mounted thereon and positioned adjacent said rollers for washing debris from the elongated member before being pulled therethrough.
